(19) United States
(12) Patent Application Publication
(10) Pub. No.: US 2025/0198434 A1
(43) Pub. Date: Jun. 19, 2025

(54) LATCH MECHANISM FOR A PROTECTIVE CASE

(71) Applicants: Chao Chen, Marina Del Rey, CA (US); Dinh Tu Huynh, Los Angeles, CA (US); Mark Kraz, Los Gatos, CA (US); Chirag Somani, Henderson, NV (US)

(72) Inventors: Chao Chen, Marina Del Rey, CA (US); Dinh Tu Huynh, Los Angeles, CA (US); Mark Kraz, Los Gatos, CA (US); Chirag Somani, Henderson, NV (US)

(21) Appl. No.: 18/545,776

(22) Filed: Dec. 19, 2023

(51) Int. Cl. F16B 2/02; B65D 81/02; B65D 85/38

(52) U.S. Cl. CPC F16B 2/02; B65D 81/02; B65D 85/38

(57) ABSTRACT

A protective case for a device includes a cover portion configured to fit over the device, and a latch mechanism to secure the cover portion to the device. The latch mechanism has a latch rotatable about a first axis, and a ring spring rotatable about a second axis different from the first axis. Rotation of the latch about the first axis causes a deformation of the ring spring to generate a variable latch closing force that varies with rotation of the latch. In some embodiments, rotation of the latch compresses the ring spring to generate the variable latch closing force which increases to a maximum at a maximum compression point of the ring spring at a predetermined latch rotation angle. The ring spring then biases the latch open or closed depending on direction of rotation. The variable latch closing force is sufficient to adhere the cover portion to the device upon an impact. The protective case provides secure impact protection for augmented reality glasses, head-mounted displays, and other devices, with smooth latch operation.

### BACKGROUND

Augmented reality (AR) devices are becoming increasingly popular for applications such as gaming, content interaction, navigation, and other hands-free computing tasks. To protect sensitive AR device components from damage, protective cases are sometimes used to cover the AR glasses or headsets. Sometimes, these protective cases utilize latches or other fastening mechanisms to securely adhere the case over the AR device housing.

Conventional latches for protective cases use simple designs that typically exhibit an abrupt engagement as the latch snaps closed. The abrupt closure can require significant closing force and a loud snapping or “click” sound can be unpleasant. Upon impact or dropping, basic latch designs may not supply adequate clamping force to keep the protective case securely fastened. Additionally, conventional latches typically provide a static closing force regardless of the latch position.

### BRIEF DESCRIPTION OF THE DRAWINGS

In the drawings, which are not necessarily drawn to scale, like numerals may describe similar components in different views. Some nonlimiting examples are illustrated in the figures of the accompanying drawings.

FIG. 1 illustrates pictorial views of an example electronic device and protective case in accordance with some embodiments.

FIG. 2 illustrates a part sectional view of a protective case fitted to a device in accordance with one embodiment.

FIG. 3 illustrates a pictorial view of example components of a latch mechanism in accordance with one embodiment.

FIG. 4-FIG. 7B illustrate pictorial and ghosted views of certain internal components of a latch mechanism in accordance with some embodiments.

FIG. 8A-FIG. 8D illustrate aspects relating to generating a variable latching force in accordance with some embodiments.

FIG. 9 illustrates a method 900 in accordance with one embodiment.

### DETAILED DESCRIPTION

As mentioned above, there are several drawbacks pertaining to conventional protective covers and latch mechanisms. Some examples herein seek to address these drawbacks and provide an innovative latch design utilizing a single ring spring component to provide dynamic variable closing force, easy opening, and secure clamping force in a compact, durable configuration. A unique arrangement of a rotating latch and integrated ring spring seeks to provide substantial improvements over conventional latch mechanisms and can enhance protection, usability, and the overall user experience. These and other aspects are now described with reference to some specific examples.

The present disclosure relates to a protective case for a device that includes a cover portion configured to fit over the device, and a latch mechanism to secure the cover portion to the device. The latch mechanism has a latch rotatable about a first axis, and a ring spring rotatable about a second axis different from the first axis. Rotation of the latch about the first axis causes a deformation of the ring spring to generate a variable latch closing force that varies with rotation of the latch.

In some embodiments, rotation of the latch compresses the ring spring to generate the variable latch closing force which increases to a maximum at a maximum compression point of the ring spring at a predetermined latch rotation angle. The ring spring then biases the latch open or closed depending on direction of rotation. The variable latch closing force is sufficient to adhere the cover portion to the device upon an impact. The protective case provides secure impact protection for augmented reality glasses, head-mounted displays, and other devices, with smooth latch operation.

The present disclosure also relates to a latch mechanism for securing a protective case or cover to augmented reality (AR) glasses or other devices. The latch mechanism is designed to lock the protective cover or case securely to the AR device frame while also providing a smooth, variable opening and closing operation.

In some examples, the latch mechanism utilizes a ring spring mounted inside the latch assembly. The ring spring has a different axis of rotation compared to the axis of the latch itself. As the latch is rotated from an open to closed position, the changing overlap or distance between these axes causes the ring spring to be compressed by different amounts. This compression generates a variable closing or opening force that can, for example, start low and then increase until a certain point or degree of latch rotation. The latch snaps securely closed beyond the certain rotation point.

Conversely, once opened or returned past the certain point of latch rotation the spring decompresses and provides an opening force to allow the latch to pop back open easily when released. This arrangement provides in one direction a smooth, gradual increase in closing force and in another direction an easy release. The arrangement of the ring spring and rotating latch provides dynamic latch forces that enhance the user experience and security. Other latch force profiles are possible.

In further aspects, in the closed position, the ring spring generates sufficient clamping force to adhere the protective cover to the AR device. This clamping force keeps the protective cover securely in place in case the glasses are dropped or impacted, preventing dislodgment of the cover. The latch mechanism thereby protects the AR glasses by maintaining full coverage of the protective casing.

Some examples thus provide an innovative latch design utilizing a single ring spring component to provide dynamic variable closing force, easy opening, and secure clamping force in a compact, durable configuration. A unique arrangement of a rotating latch and integrated ring spring seeks to provide substantial improvements over conventional latch mechanisms and can enhance protection, usability, and the overall user experience.

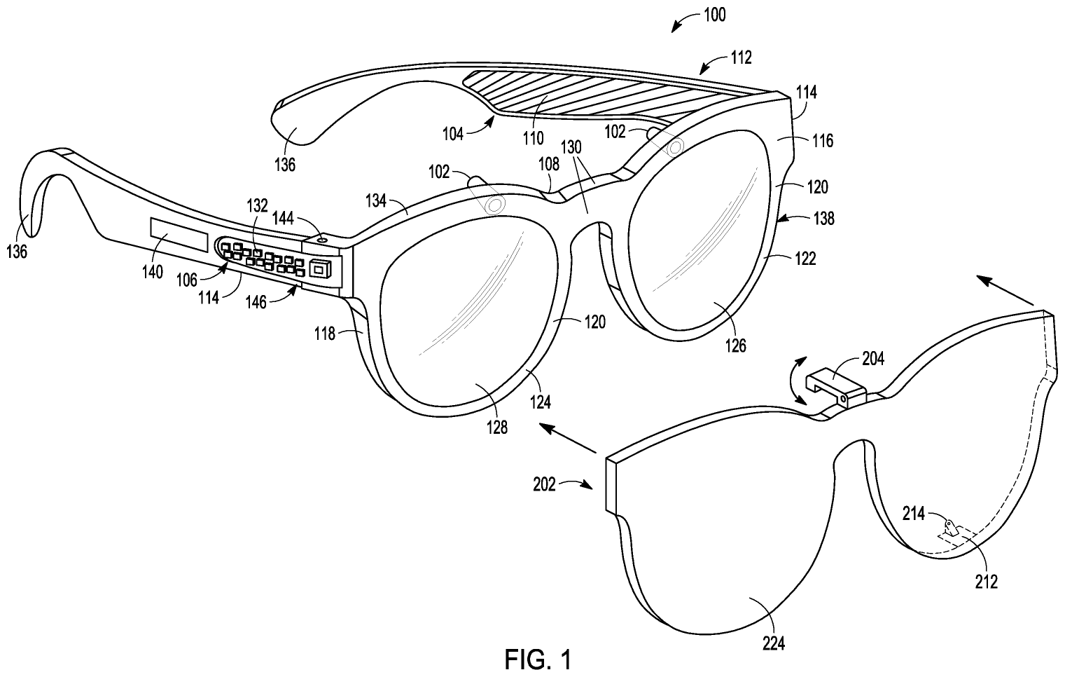

FIG. 1 shows a perspective view of a head-wearable user device to which a protective case 202 according to present examples can be fitted as described further below. The protective case 202 and its connection elements are shown in schematic form only. Other shapes and configurations of connection elements are possible. In this example, the head-wearable user device is shown as an AR eyewear device (e.g., the glasses 100), in accordance with some example embodiments. Other devices are possible, such as standard spectacles, an augmented reality visor or googles, a head-mounted display, or a handheld electronic device. The glasses 100 in this instance can be worn to view augmented or virtual content displayed over real content visible through the optical elements 126, 128 in a content interaction system.

The protective case 202 includes a cover portion 224 and, as a first connection element, a latch mechanism 204 is provided on a upper end or edge of the protective case 202 in the view. The cover portion 224 is solid and is configured to fit over the glasses 100 as shown to protect sensitive elements thereof, for example the left optical element 126 and the right optical element 128. Other protected elements are possible. At the lower end of the protective case 202 in the view, a second connection element in the form of alignment detent 212 is shown. The alignment detent 212 may include a boss 214 that locks behind the frame 112 of the glasses 100, as shown.

By way of example only, the glasses 100 of FIG. 1 include a small frame 112 made from any suitable material such as plastic or metal, including any suitable shape memory alloy, as is well known for ophthalmic eyewear. In one or more embodiments, the frame 112 includes a front piece 138, including a first or left (as worn by a user) optical element holder 122 (e.g., a display or lens holder) and a second or right (as worn by a user) optical element holder 124, connected by a nose piece or bridge 130. The front piece 138 additionally includes a left end portion 116 and a right end portion 118. A first or left optical element 126 and a second or right optical element 128 can be provided within respective left optical element holder 122 and right optical element holder 124. Each of the right optical elements 128 and the left optical elements 126 can be a lens, a display, a display assembly, or a combination of the foregoing. Any of the display assemblies disclosed herein can be provided in the glasses 100.

The frame 112 additionally includes a left arm or temple piece 104 and a right arm or temple piece 106 coupled to the respective left end portion 116 and the right end portion 118 of the front piece 138 by any suitable means such as at a folding hinge 144 (one folding hinge 144 on each side), so as to be coupled to the front piece 138, or rigidly or otherwise secured to the front piece 138 so as to be integral with the front piece 138. In one or more implementations, each of the temple pieces 104 and the temple pieces 106 includes a first portion 114 that is coupled to the respective left end portion 116 or right end portion 118 of the front piece 138 and any suitable second portion 136 for coupling to the ear of the user. In one embodiment, the front piece 138 can be formed from a single piece of material, so as to have a unitary or integral construction. In one embodiment, such as illustrated in FIG. 1, the entire frame 112 can be formed from a single piece of material so as to have a unitary or integral construction.

The glasses 100 can include a computing device, such as a computer 132, which can be of any suitable type so as to be carried by the frame 112 and, in one or more embodiments of a suitable size and shape, so as to be at least partially disposed in one of the temple pieces 104 and the temple pieces 106. In one or more embodiments, as illustrated in FIG. 1, the computer 132 is sized and shaped similar to the size and shape of one of the temple pieces 106 (e.g., or the temple piece 104), and is thus disposed almost entirely, if not entirely, within the structure and confines of such temple piece 106. In one or more embodiments, the computer 132 is disposed in both of the temple piece 104 and the temple piece 106 and flexible circuits connecting the two parts of the computer 132 pass through one (or typically both) of the folding hinges 144. The computer 132 can include one or more printed circuit boards (PCBs) and one or more hardware processors with memory, wireless communication circuitry, and a power source. In some examples, the computer 132 comprises low-power circuitry, high-speed circuitry, and a display processor. Various other embodiments may include these elements in different configurations or integrated together in different ways.

Electronic devices such as augmented reality glasses, mobile phones, and wearable devices generate significant heat during operation. Components like the PCBs, CPU, GPU, screens, lenses, surface-mount devices (SMDs), Systems on a Chip (SOCs), sensors, and transmitters can significantly raise the internal temperature of the device. Some examples herein provide an efficient runtime prediction technique that can dynamically estimate when an electronic device or one or more of its components will exceed a safe operating temperature, given current conditions. Such a prediction provided by examples herein can allow developers to improve product and circuit designs, including thermal management and/or cooling. Such predictions can also allow the device to take proactive measures like warning the user, throttling, saving state, and gracefully shutting down before an emergency shutdown occurs. In some examples, the prediction accounts for parameters like sensor temperatures, processing load, and ambient temperature. Some examples are lightweight and compact enough to run continuously on resource-constrained devices, such as the glasses 100.

The computer 132 additionally includes a battery 110 or other suitable portable power supply. In one embodiment, the battery 110 is disposed in one of the temple pieces 104 or the temple piece 106. In the glasses 100 shown in FIG. 1, the battery 110 is shown as being disposed in left temple piece 104 and electrically coupled using the connection 134 to the remainder of the computer 132 disposed in the right temple piece 106. The glasses 100 can include a connector or port (not shown) suitable for charging the battery 110 accessible from the outside of frame 112, a wireless receiver, transmitter, or transceiver (not shown) or a combination of such devices.

In one or more implementations, the glasses 100 include cameras 102. Although two cameras are depicted, other embodiments contemplate the use of a single or additional (i.e., more than two) cameras. In one or more embodiments, the glasses 100 include any number of input sensors or peripheral devices in addition to the cameras 102. The front piece 138 is provided with an outward facing, forward-facing, or front or outer surface 120 that faces forward or away from the user when the glasses 100 are mounted on the face of the user, and an opposite inward-facing, rearward-facing, or rear or inner surface 108 that faces the face of the user when the glasses 100 are mounted on the face of the user. Such sensors can include inwardly-facing video sensors or digital imaging modules, such as cameras that can be mounted on or provided within the inner surface 108 of the front piece 138 or elsewhere on the frame 112 so as to be facing the user, and outwardly-facing video sensors or digital imaging modules such as the cameras 102 that can be mounted on or provided with the outer surface 120 of the front piece 138 or elsewhere on the frame 112 so as to be facing away from the user.

Such sensors, peripheral devices or peripherals can additionally include biometric sensors, ambient condition sensors, light sensors, temperature sensors, location sensors, Power Monitors, or any other such sensors. In one or more implementations, the glasses 100 include a track pad 140 or other touch or sensory input device to receive navigational commands from the user. One or more track pads 140 may be provided at convenient locations for user interaction on one or both of the track pad 140 and the temple piece 106.

In some examples, a PCB of the computer 132 includes a flexible section 146. In some examples, the flexible section 146 is located at or adjacent to the folding hinge 144. More specifically, the flexible section 146 may be located in a region either side of or crossing the (or each) folding hinge 144. The flexible section 146 adjacent a folding hinge 144 may undergo a degree of bending, flexing, or movement when the left and right arms 104 and 106 of the glasses 100 are opened and closed, for example.

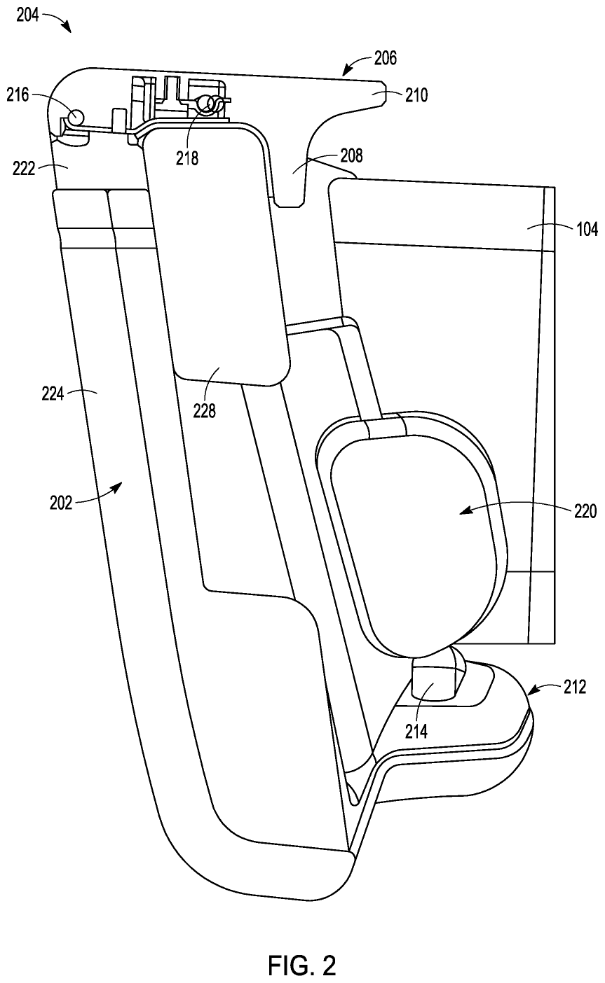

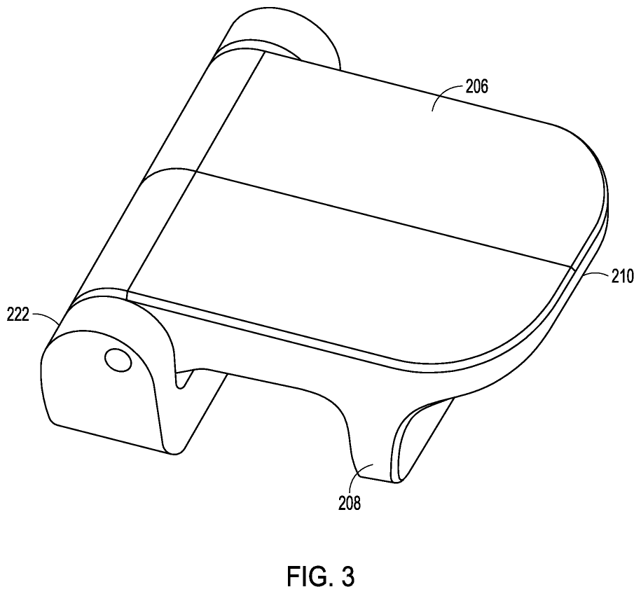

With reference to FIG. 2, an example protective case 202 is shown in part sectional view fitted to a device, in this case the glasses 100 of FIG. 1. The protective case 202 includes a cover portion 224 and a latch mechanism 204 provided on an upper end or edge of the protective case 202 in the view. The cover portion 224 is solid and is configured to fit over the glasses 100 as shown to protect sensitive elements thereof, for example the left optical element 126 and the right optical element 128. Other protected elements are possible. A non-sectioned example nose guard 220 and a temple piece 104 (beyond the nose guard 220 deeper into the page) are visible in the view. At the lower end of the protective case 202 in the view, an alignment detent 212 is shown. This element corresponds to the similar element 212 shown in FIG. 1. The alignment detent 212 may include a boss 214 that locks behind the frame 112 of the glasses 100, as shown.

The latch mechanism 204 is configured to secure the cover portion 224 to the glasses 100, for example at the nose piece or bridge 130 shown in sectional view. This is the position of the latch mechanism 204 shown in FIG. 1, for example, but other mounting locations of the latch mechanism 204 are possible, for example at another location of the frame 112 of the glasses 100. Two latch mechanisms 204 may be provided, for example one above each optical element of the glasses 100.

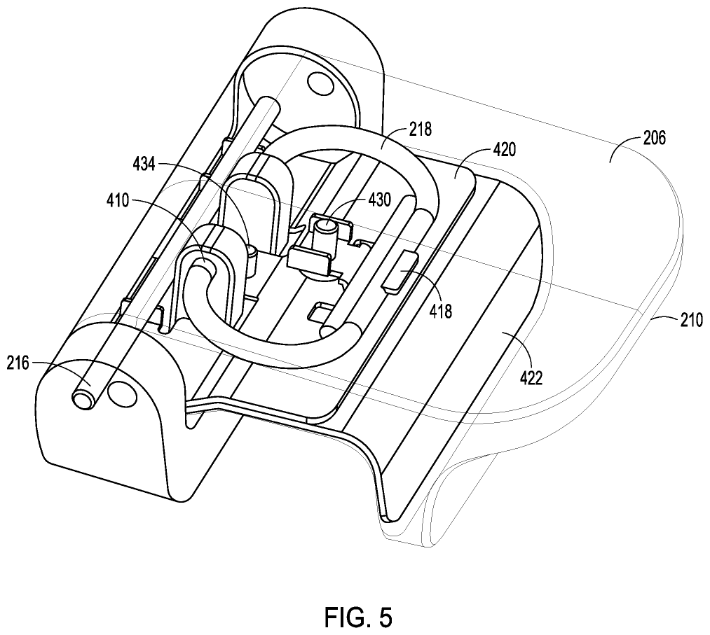

The latch mechanism 204 comprises a latch 206 that is rotatable about a first axis of rotation 216 and a ring spring 218 (or deformable “O spring”) that is rotatable about a second axis of rotation 410 as described more fully below. The second axis of rotation 410 is differently located to the first axis of rotation 216 such that rotation of the latch 206 about the first axis of rotation 216 causes a deformation of the ring spring 218 to generate a variable latch closing force that varies with rotation of the latch 206 about the first axis of rotation 216. The internal components of the latch mechanism 204 can be seen more clearly in FIGS. 4 and 5, for example.

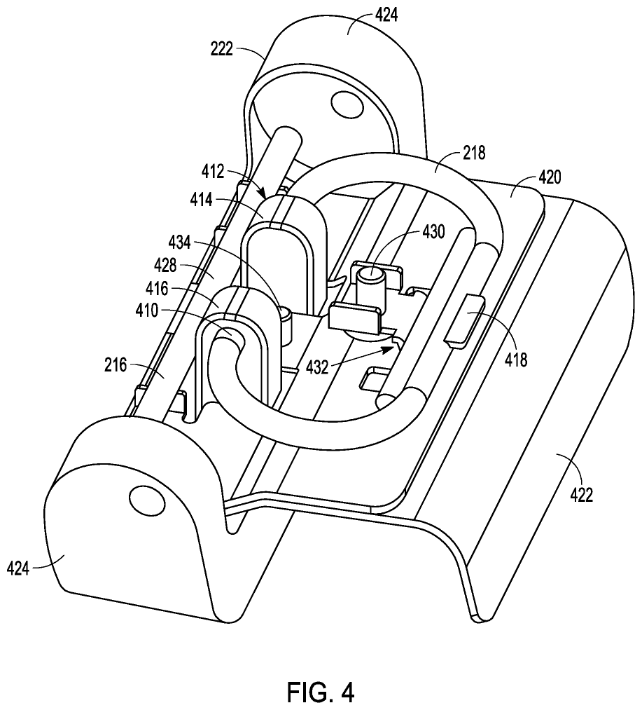

With reference again to FIG. 2 and the pictorial view of FIG. 3, the latch mechanism 204 includes a base 222 on which the first axis of rotation 216 is provided and a latch extension 208 that locks behind the nose piece or bridge 130 when the latch 206 of the latch mechanism 204 is closed. The latch 206 includes a finger grip 210 for manipulation of the latch 206 between open and closed positions of the latch 206 when securing or releasing the protective case 202 to or from the glasses 100.

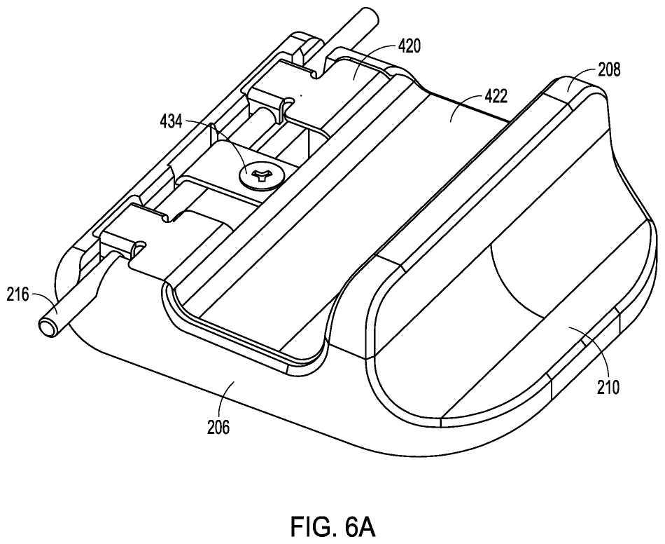

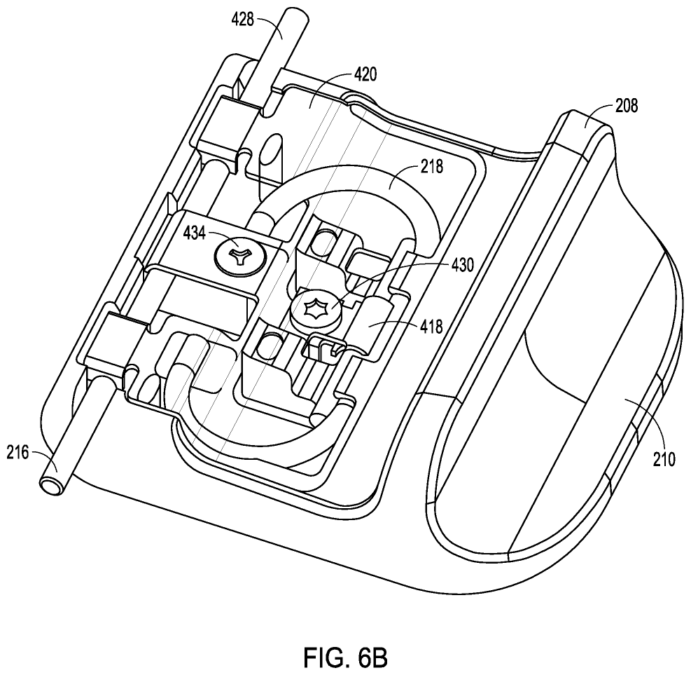

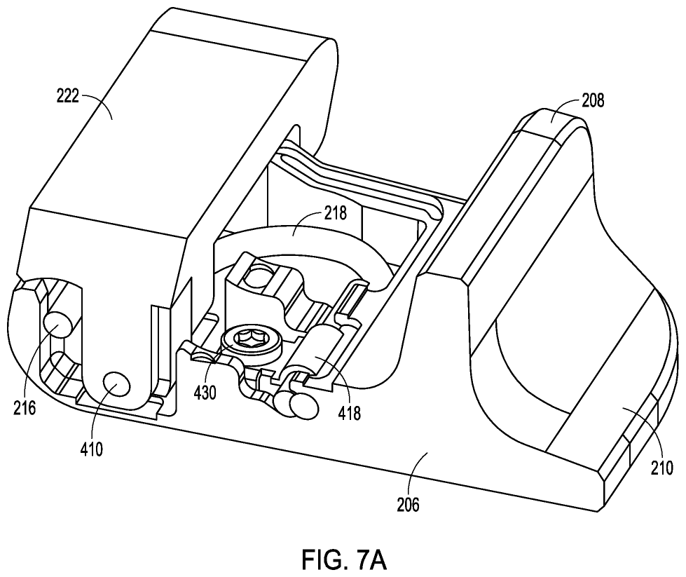

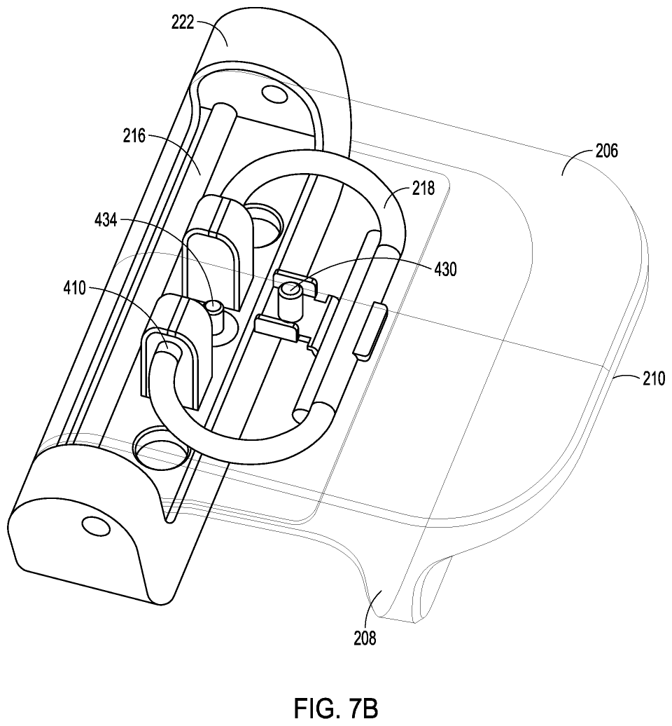

FIGS. 4 show underside pictorial views of certain internal components of the latch mechanism 204. The base 222 carries an elongate rod 428 extending between opposed bosses 424 of the base 222. The elongate rod 428 supports the latch 206 rotatably and defines the first axis of rotation 216 of the rotatable latch 206, for example as shown more clearly in FIG. 6A, FIG. 6B, FIG. 7A, and FIG. 7B. The ring spring 218 is rotatably supported about the second axis of rotation 410 by a first ring spring base 414 and a second ring spring base 416. These elements are also supported by the base 222. In this example version, the ring spring 218 is thus discontinuous about its periphery or profile. A gap exists between the first ring spring base 414 and the second ring spring base 416. In other examples, the ring spring 218 may be continuous and be circular, oval, or ellipsoid in profile. Other profiles and cross sectional shapes of the ring spring 218 are possible to generate different latching forces.

At an opposite side of the ring spring 218, it is attached to the latch 206 by a ring spring compression holder 418. In some examples, a distal portion of the ring spring 218 can move somewhat between free (un-deformed) and compressed (deformed) configurations in the ring spring compression holder 418. This partial degree of movement is intended to be shown by the “double” lines of the ring spring 218 held in a channel 432 of the ring spring compression holder 418 as shown in FIG. 4 and FIG. 5, for example. An opposite or underside side of the ring spring compression holder 418 can be seen in the ghosted view of FIG. 6B. The ring spring compression holder 418 is secured by a first threaded screw 430 to a first latch plate 420 which is in turn secured to a second latch plate 422. Both the first latch plate 420 and the second latch plate 422 are secured to or form part of the latch 206 as internal or surface components thereof, for example as shown more clearly in FIG. 6A and FIG. 6B. The first latch plate 420 is secured to the latch 206 by as second threaded screw 434 as shown more clearly in FIG. 6A. In some examples, the protective case 202 case may also include impact absorbing materials lining an interior surface of the latch, such as the first latch plate 420 and/or the second latch plate 422. The protective case 202 may also include impact absorbing materials lining an interior surface of the cover portion 224.

Thus, in sum it may be seen that a proximal portion of the latch 206 is rotatably attached to the latch mechanism 204 at the first axis of rotation 216, and a proximal portion of the ring spring 218 is rotatably attached to the latch mechanism 204 at the second axis of rotation 410, and a distal portion of the ring spring 218 is attached to the latch 206. The first axis of rotation 216 and the second axis of rotation 410 are differently located to induce deformation of the ring spring 218 as described more fully below.

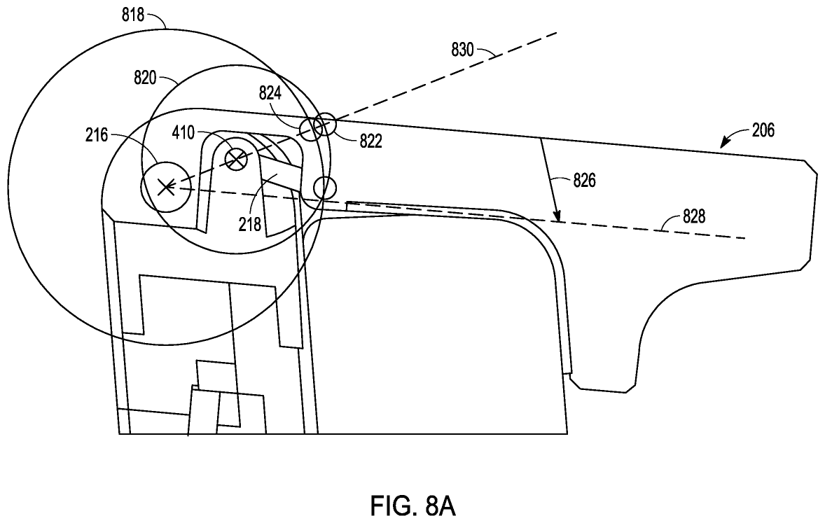

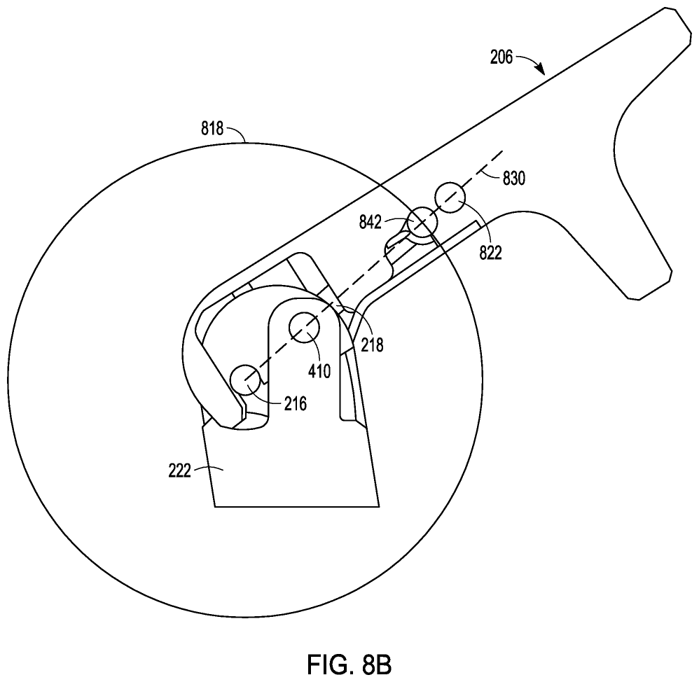

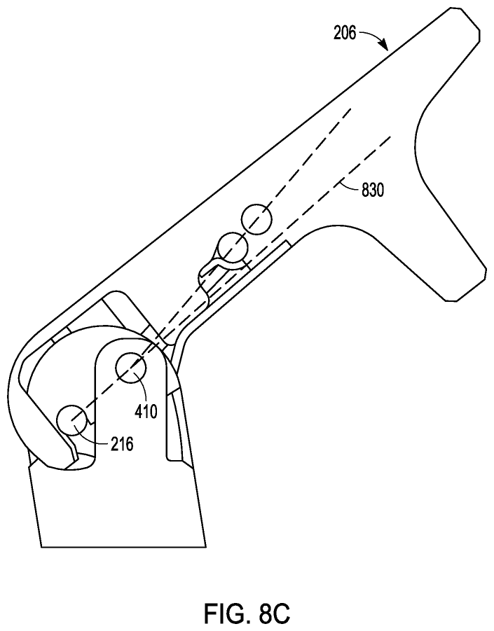

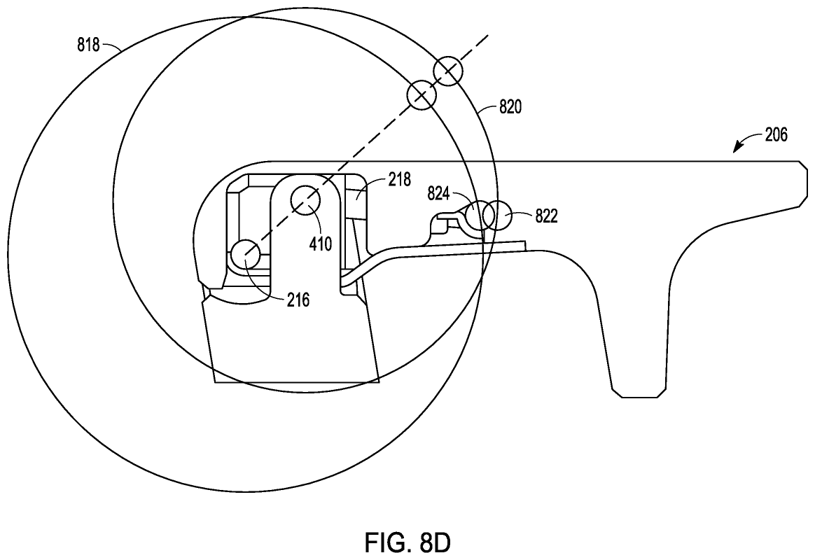

Reference is now made to FIG. 8A-FIG. 8D in this regard. With reference in particular to FIG. 8A, the first axis of rotation 216 of the latch 206 and the second axis of rotation 410 of the ring spring 218 may be seen. The first axis of rotation 216 and the second axis of rotation 410 are provided in the latch mechanism 204 as described above. A first imaginary circle of rotation 818 is shown around the first axis of rotation 216. A portion of the first imaginary circle of rotation 818 represents an arc of travel followed by the latch 206 rotating about the first axis of rotation 216 between opened and closed positions, for example.

A second imaginary circle of rotation 820 is shown around the second axis of rotation 410. A portion of this second imaginary circle of rotation 820 represents an arc of travel that would be followed by a free ring spring 218, in other words a ring spring 218 unrestrained by the ring spring compression holder 418. Such an unrestrained distal portion of the ring spring 218 would pass through a hypothetical spring free position 822, as shown, following the second imaginary circle of rotation 820. However, as the distal portion of the ring spring 218 is secured to the latch 206 by the ring spring compression holder 418, the ring spring 218 (or at least the held distal portion thereof) is constrained to follow the first imaginary circle of rotation 818 and pass through an actual rotate position 824. The ring spring 218 deforms (compresses inwardly in this example) to generate a dynamically variable latching force.

In some examples, a separation angle 826 or predetermined angle of rotation of the latch is provided at which a maximum compression force of the ring spring 218 is generated. In the illustrated view, this position of maximum compression force coincides with the actual rotate position 824, but other arrangements are possible. Either side of this latch 206 rotational position, the latching force generated by the ring spring 218 decreases. In other words, an apex of force is reached at the separation angle 826. In some examples, as shown, the separation angle 826 is defined by an angle separating the main plane 828 of the latch 206 and a line 830 passing through the first axis of rotation 216 and the second axis of rotation 410. In some examples, the separation angle 826 is in the range of 30 to 60 degrees. In some examples, the separation angle 826 is approximately 40 degrees.

The arrangement of the latch mechanism 204 is such that rotation of the latch 206 about the first axis of rotation 216 causes a deformation, in this case a compression, of the ring spring 218 to generate the variable latch closing force. The variable latch closing force increases to a maximum at a maximum compression point of the ring spring 218 at a predetermined degree of rotation of the latch 206 about the first axis of rotation 216, for example at the separation angle 826. In some examples, the maximum compression point of the ring spring 218 occurs at an intermediate position of the latch 206 between a fully open position and a fully closed position of the latch 206 at which the latch secures the cover portion 224 to the device e.g., the glasses 100. The illustrated instance is an example of this kind of arrangement. In other examples, the maximum compression point of the ring spring 218 occurs at a fully open, or a fully closed position of the latch 206 at which the latch 206 secures the cover portion 224 to the device.

In some examples, when rotated either side of the force apex, for example in FIG. 8C, the ring spring 218 generates an upward (or opening) component of latching force to bias or assist the latch 206 to open when the latch 206 is rotated in an opening direction i.e., upwards in the view of FIG. 8A between the predetermined degree of rotation (e.g., the separation angle 826) and the fully open position of the latch 206. In some examples, for example in FIG. 8D, the ring spring 218 generates a downward (or closing) component of latching force to bias or assist the latch 206 to close when the latch 206 is rotated in a closing direction between the predetermined degree of rotation (e.g., the separation angle 826) and the fully closed position of the latch 206. In some examples, again with reference to FIG. 8D, the variable latch closing force is sufficient to adhere the cover portion 224 to the device (e.g., the glasses 100) upon an impact.

As mentioned above, in some examples, the ring spring 218 includes a closed (or open) ring shape. In some examples, the ring spring 218 compresses from a relatively circular shape to a relatively elliptical shape as the latch 206 is rotated from an open position to a closed position. In some examples, the protective case 202 may also include one or more alignment features, for example an alignment detent 212 and/or boss 214, configured to engage with corresponding features on the device (e.g., the glasses 100) to align the cover portion 224 into a predetermined position over the device. In some examples, the cover portion 224 portion is transparent or semi-transparent to allow viewing of the device.

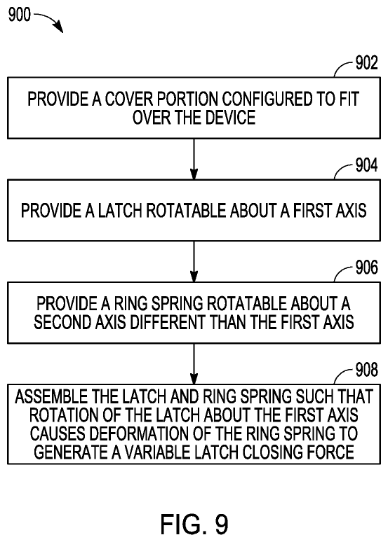

Some embodiments also include methods. FIG. 9 is a flowchart illustrating a method 900, according to an example embodiment, of manufacturing a protective case for a device. Although the described flow diagram below can show operations as a sequential process, many of the operations can be performed in parallel or concurrently. In addition, the order of the operations may be re-arranged. A process is terminated when its operations are completed. The operations of methods may be performed in whole or in part, may be performed in conjunction with some or all of the operations in other methods, and may be performed by any number of different systems.

In operation 902, the method 900 provides a cover portion configured to fit over the device. In operation 904, method 900 provides a latch rotatable about a first axis. In operation 906, method 900 provides a ring spring rotatable about a second axis different than the first axis. In operation 908, method 900 assembles the latch and ring spring such that rotation of the latch about the first axis causes deformation of the ring spring to generate a variable latch closing force.

The method 900 may also include attaching a proximal portion of the latch at the first axis and a proximal portion of the ring spring at the second axis to a latch mechanism.

The method 900 may also include rotatably attaching a distal portion of the ring spring to the latch such that rotation of the latch deforms the ring spring.

The method 900 may also include where the ring spring is rotatably attached to the latch by a ring spring compression holder secured to the latch.

The method 900 may also include configuring the latch and ring spring such that a maximum compression point of the ring spring occurs at an intermediate position of the latch between a fully open position and a fully closed position.

The method 900 may also include incorporating impact absorbing materials on an interior surface of the latch.

Other technical features may be readily apparent to one skilled in the art from the following figures, descriptions, and claims.

### EXAMPLES

Thus, some embodiments may include one or more of the following examples.

Example 1. A protective case for a device comprising: a cover portion configured to fit over the device; a latch mechanism configured to secure the cover portion to the device, wherein the latch mechanism comprises: a latch rotatable about a first axis; and a ring spring rotatable about a second axis different from the first axis; wherein rotation of the latch about the first axis causes a deformation of the ring spring to generate a variable latch closing force that varies with rotation of the latch about the first axis.

Example 2. The protective case of example 1, wherein rotation of the latch about the first axis causes a compression of the ring spring to generate the variable latch closing force.

Example 3. The protective case of example 1 or example 2, wherein the variable latch closing force increases to a maximum at a maximum compression point of the ring spring at a predetermined degree of rotation of the latch about the first axis.

Example 4. The protective case of any one of examples 1-3, wherein the maximum compression point of the ring spring occurs at an intermediate position of the latch between a fully open position and a fully closed position of the latch at which the latch secures the cover portion to the device.

Example 5. The protective case of any one of examples 1-4, wherein the maximum compression point of the ring spring occurs at a fully closed position of the latch at which the latch secures the cover portion to the device.

Example 6. The protective case of any one of examples 1-5, wherein the ring spring biases the latch open when the latch is rotated in an opening direction between the predetermined degree of rotation and the fully open position of the latch.

Example 7. The protective case of any one of examples 1-6, wherein the ring spring biases the latch closed when the latch is rotated in a closing direction between the predetermined degree of rotation and the fully closed position of the latch.

Example 8. The protective case of any one of examples 1-7, wherein a proximal portion of the latch is rotatably attached to the latch mechanism at the first axis, and wherein a proximal portion of the ring spring is rotatably attached to the latch mechanism at the second axis, and wherein a distal portion of the ring spring is attached to the latch.

Example 9. The protective case of any one of examples 1-8, wherein the variable latch closing force is sufficient to adhere the cover portion to the device upon an impact.

Example 10. The protective case of example 1, wherein the ring spring comprises a closed ring shape.

Example 11. The protective case of any one of examples 1-10, wherein the ring spring compresses from a relatively circular shape to a relatively elliptical shape as the latch is rotated from an open position to a closed position.

Example 12. The protective case of any one of examples 1-11, further comprising one or more alignment features configured to engage with corresponding features on the device to align the cover portion into a predetermined position over the device.

Example 13. The protective case of any one of examples 1-12, further comprising impact absorbing materials lining an interior surface of the latch.

Example 14. The protective case of any one of examples 1-13, further comprising impact absorbing materials lining an interior surface of the cover portion.

Example 15. The protective case of any one of examples 1-14, wherein the device comprises augmented reality glasses, a head-mounted display, or a handheld electronic device.

Example 16. The protective case of any one of examples 1-15, wherein the cover portion is transparent or semi-transparent to allow viewing of the device.

Example 17. A latch mechanism for securing a protective cover to a device, wherein the latch mechanism comprises: a latch rotatable about a first axis; and a ring spring rotatable about a second axis different from the first axis; wherein rotation of the latch about the first axis causes a deformation of the ring spring to generate a variable latch closing force that varies with rotation of the latch about the first axis.

Example 18. The latch mechanism of example 17, wherein rotation of the latch about the first axis causes a compression of the ring spring to generate the variable latch closing force.

Example 19. The latch mechanism of example 17 or example 18, wherein the variable latch closing force increases to a maximum at a maximum compression point of the ring spring at a predetermined degree of rotation of the latch about the first axis.

Example 20. The latch mechanism of any one of examples 17-19, wherein the maximum compression point of the ring spring occurs at an intermediate position of the latch between a fully open and a fully closed position of the latch at which the latch secures the protective cover to the device.

Example 21. A method of manufacturing a protective case for a device, the method comprising: providing a cover portion configured to fit over the device; providing a latch rotatable about a first axis; providing a ring spring rotatable about a second axis different than the first axis; and assembling the latch and the ring spring such that rotation of the latch about the first axis causes deformation of the ring spring to generate a variable latch closing force.

Example 22. The method of example 21, further comprising attaching a proximal portion of the latch at the first axis and a proximal portion of the ring spring at the second axis to a latch mechanism.

Example 23. The method of example 21 or example 22, further comprising rotatably attaching a distal portion of the ring spring to the latch such that rotation of the latch deforms the ring spring.

Example 24. The method of any one of examples 21-23, wherein the ring spring is rotatably attached to the latch by a ring spring compression holder secured to the latch.

Example 25. The method of any one of examples 21-24, further comprising configuring the latch and the ring spring such that a maximum compression point of the ring spring occurs at an intermediate position of the latch between a fully open position and a fully closed position.

Example 26. The method of any one of examples 21-25, further comprising incorporating impact absorbing materials on an interior surface of the latch.

Although an embodiment has been described with reference to specific example embodiments, it will be evident that various modifications and changes may be made to these embodiments without departing from the broader scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This detailed description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “example” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A protective case for a device comprising:
a cover portion configured to fit over the device;
a latch mechanism configured to secure the cover portion to the device, wherein the latch mechanism comprises:
a latch rotatable about a first axis; and
a ring spring rotatable about a second axis different from the first axis;
wherein rotation of the latch about the first axis causes a deformation of the ring spring to generate a variable latch closing force that varies with rotation of the latch about the first axis.

2. The protective case of claim 1, wherein rotation of the latch about the first axis causes a compression of the ring spring to generate the variable latch closing force.

3. The protective case of claim 2, wherein the variable latch closing force increases to a maximum at a maximum compression point of the ring spring at a predetermined degree of rotation of the latch about the first axis.

4. The protective case of claim 3, wherein the maximum compression point of the ring spring occurs at an intermediate position of the latch between a fully open position and a fully closed position of the latch at which the latch secures the cover portion to the device.

5. The protective case of claim 3, wherein the maximum compression point of the ring spring occurs at a fully closed position of the latch at which the latch secures the cover portion to the device.

6. The protective case of claim 4, wherein the ring spring biases the latch open when the latch is rotated in an opening direction between the predetermined degree of rotation and the fully open position of the latch.

7. The protective case of claim 4, wherein the ring spring biases the latch closed when the latch is rotated in a closing direction between the predetermined degree of rotation and the fully closed position of the latch.

8. The protective case of claim 1, wherein a proximal portion of the latch is rotatably attached to the latch mechanism at the first axis, and wherein a proximal portion of the ring spring is rotatably attached to the latch mechanism at the second axis, and wherein a distal portion of the ring spring is attached to the latch.

9. The protective case of claim 1, wherein the variable latch closing force is sufficient to adhere the cover portion to the device upon an impact.

10. The protective case of claim 1, wherein the ring spring comprises a closed ring shape.

11. The protective case of claim 1, wherein the ring spring compresses from a relatively circular shape to a relatively elliptical shape as the latch is rotated from an open position to a closed position.

12. The protective case of claim 1, further comprising one or more alignment features configured to engage with corresponding features on the device to align the cover portion into a predetermined position over the device.

13. The protective case of claim 1, further comprising impact absorbing materials lining an interior surface of the latch.

14. The protective case of claim 1, further comprising impact absorbing materials lining an interior surface of the cover portion.

15. The protective case of claim 1, wherein the device comprises augmented reality glasses, a head-mounted display, or a handheld electronic device.

16. The protective case of claim 1, wherein the cover portion is transparent or semi- transparent to allow viewing of the device.

17. A latch mechanism for securing a protective cover to a device, wherein the latch mechanism comprises:
a latch rotatable about a first axis; and
a ring spring rotatable about a second axis different from the first axis;
wherein rotation of the latch about the first axis causes a deformation of the ring spring to generate a variable latch closing force that varies with rotation of the latch about the first axis.

18. The latch mechanism of claim 17, wherein rotation of the latch about the first axis causes a compression of the ring spring to generate the variable latch closing force.

19. The latch mechanism of claim 18, wherein the variable latch closing force increases to a maximum at a maximum compression point of the ring spring at a predetermined degree of rotation of the latch about the first axis.

20. The latch mechanism of claim 19, wherein the maximum compression point of the ring spring occurs at an intermediate position of the latch between a fully open and a fully closed position of the latch at which the latch secures the protective cover to the device.

21. A method of manufacturing a protective case for a device, the method comprising:
providing a cover portion configured to fit over the device;
providing a latch rotatable about a first axis;
providing a ring spring rotatable about a second axis different than the first axis; and
assembling the latch and the ring spring such that rotation of the latch about the first axis causes deformation of the ring spring to generate a variable latch closing force.

22. The method of claim 21, further comprising attaching a proximal portion of the latch at the first axis and a proximal portion of the ring spring at the second axis to a latch mechanism.

23. The method of claim 21, further comprising rotatably attaching a distal portion of the ring spring to the latch such that rotation of the latch deforms the ring spring.

24. The method of claim 23, wherein the ring spring is rotatably attached to the latch by a ring spring compression holder secured to the latch.

25. The method of claim 21, further comprising configuring the latch and the ring spring such that a maximum compression point of the ring spring occurs at an intermediate position of the latch between a fully open position and a fully closed position.

26. The method of claim 21, further comprising incorporating impact absorbing materials on an interior surface of the latch.
